(19) United States
(12) Patent Application Publication
(10) Pub. No.: US 2008/0065429 A1
(43) Pub. Date: Mar. 13, 2008

(54) Method and system for advertising and managing one or more vacation rental properties worldwide via a network

(76) Inventor: Ryan Galloway, San Francisco, CA (US)

Correspondence Address: Ryan S. Galloway, 1526 Pershing Drive, Apt. A, San Francisco, CA, 94129, US

(21) Appl. No.: 11/523,340

(22) Filed: Sep. 19, 2006

Related U.S. Application Data
(60) Provisional application No. 60/718,934, filed on Sep. 19, 2005.

(51) Int. Cl. G06Q 10/00; G06F 17/30; G06F 17/40

(52) U.S. Cl. 705/5

(57) ABSTRACT

A method and system for finding, browsing, managing, booking, rating and advertising vacation rental properties worldwide via a network such as the Internet composed of a renter reservation system, an owner management system and a plurality affiliates or publishers of Internet content established to provide goods and/or services to prospective renters and/or vacation rental property owners and works in a client/server environment by receiving, storing and tracking data associated with a vacation rental property owner, the vacation rental property itself, reservation and guest information and rental property listing click-throughs from a client system and assigns a unique identifier to each in a centralized relational database.

### CROSS-REFERENCE TO RELATED APPLICATIONS

This application is entitled to the benefit of Provisional Patent Application Ser. No. 60/718,934 filed Sep. 19, 2005.

### BACKGROUND OF THE INVENTION

1. Field of Invention

The field of this invention is advertising, browsing, managing and booking vacation rental properties worldwide using electronic means of (a) communications, (b) data storage and retrieval, (c) online reservations, (d) transfers of payments, and (e) providing customer service.

These days in the travel business, the trend is for vacationers to do all their planning online, and as the vacation rental business grows (4 out of 10 homes sold in 2005 were second homes), it needs to keep up with the latest trends in technology. Online availability calendars, up-to-date rates and online bookings are three important things renters want when dealing with vacation rental properties.

A complete system is disclosed, a method and system that meets the needs of today's Internet-oriented vacationers and vacation rental property owners.

2. Discussion of Prior Art

Traditionally, vacation rental properties generate income for their owners through rent payments and are managed by a local property management company. The owner will not typically have any visibility with respect to the process. The exposure of the owner's rental property to prospective renters is therefore left to the direction of the management company and is limited on a per-property basis because said management company has no vested interest in any single property. In addition owners are subject to various fees and expenses imposed by the management company including up to fifty percent of the gross rental income as payment for their services. Many vacation rental property owners' profits are subsequently eroded away by fees charged by avaricious management companies.

With respect to a renter, reserving a vacation rental is often a difficult task which may include multiple steps and involve a great deal of time. Even with the expansion of the Internet, the searching process is slow and cumbersome. For example, many traditional property management companies provide an Internet Listing Service (“ILS”) but only those properties which they represent are listed. All the vacation rental properties in a community or region may be spread across several disparate ILS websites and without a centralized database there is a high likelihood of double booking. For example, two different ILS websites may each reserve the same property on the same day. These, and other difficulties, create undesirable delays and frustrations for vacation rental property renters and owners, and may reduce the ability for property managers to attract renters and increase occupancy rates. Many of these features and functionalities have been unavailable due to the difficulty of aggregating data from disparate, often antiquated, property management computer systems.

Many of what I refer to as “traditional” vacation rental listing websites have become available for vacation rental owners to advertise their rentals, providing basic advertising and listings for vacation rental properties. However vacationers who browse said “traditional” websites searching for vacation rental properties are required to correspond with the owner (either via submitting information into an email form which gets sent to the owner, or by telephone) who may or may not be immediately available to answer inquiries. In addition, most inquiries are typically in regards to the availability and cost of the vacation rental property for specific dates. The owner spends a lot of time answering the same questions over and over again. Moreover, there is no established way of screening prospective renters. If a vacation rental owner decides not to rent to a particular renter or the need of the renter are not matched by the vacation rental property (for example in terms of availability, cost, amenities or location) the renter is forced to return to the original search process to find another suitable vacation rental.

Furthermore, when a vacationer actually finds a vacation rental property matching their needs, there remains the task of payment resulting from the vacationers lease obligations and the like. Because each vacation rental property is like a separate business entity, each with its own method of accepting and processing payments and refunds (for security deposit refunds for example), there is no universal method of booking and payment for renters of vacation rental properties.

### BRIEF SUMMARY OF THE INVENTION

The present invention overcomes the limitations and expenses imposed by traditional vacation rental property management methods and “traditional” vacation rental advertising websites by providing a system for finding, browsing, managing, booking, rating and advertising vacation rental properties worldwide via a network such as the Internet.

The invention is composed of a renter reservation system, an owner management system and a plurality affiliates or publishers of Internet content established to provide goods and/or services to prospective renters and/or vacation rental property owners and works in a client/server environment by receiving, storing and tracking data associated with a vacation rental property owner, the vacation rental property itself, reservation and guest information and rental property listing click-throughs from a client system and assigns a unique identifier to each in a centralized relational database.

In addition, all vacation rental property listings are subject to an instantaneous auction, among other factors, to determine their relative positioning in listing search results. Client system click-throughs are defined as when a prospective renter clicks on a vacation rental property listing provided by the affiliate's system and the full listing data is displayed on the client system. Each click-through is associated with a per-property owner-defined Cost-Per-Click (CPC) which is later tallied and invoiced to the property owner and distributed to affiliates.

### BRIEF DESCRIPTION OF THE DRAWINGS

The invention will hereinafter be described in conjunction with the appended drawing figures, wherein like numerals denote like elements, and:

FIG. 1 is a diagram illustrating an environment within which the invention may be implemented;

FIG. 2 is a diagram functionally illustrating a management system consistent with the invention;

FIG. 3 is a diagram functionally illustrating an owner tools component consistent with the invention;

FIG. 4 is a diagram functionally illustrating a vendor tools component consistent with the invention;

FIG. 5 is a diagram functionally illustrating a publisher tools component consistent with the invention;

FIG. 6 is a flowchart of an exemplary reservation request method in accordance with one aspect of the present invention.

### DETAILED DESCRIPTION OF THE INVENTION

The present invention provides a method and system for managing, reserving and listing vacation rental properties using a plurality of content providers in a client/server environment to a worldwide audience of vacation rental property owners and potential renters. In this regard, the present invention may be described in terms of functional modules or components, network diagrams, and various processing steps realized by hardware and software components configured to perform the specified functions. It should be noted that the present invention may employ conventional techniques for data transmission and processing, and the like. Such general techniques and components are known to those skilled in the art and are not described in detail herein.

A. Environment and Architecture

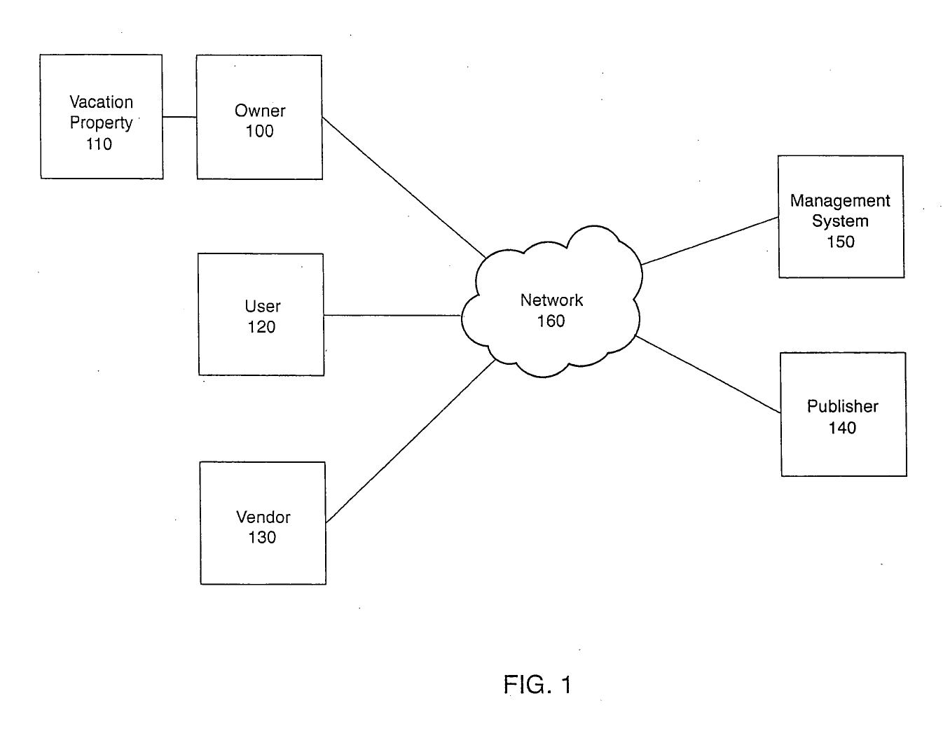

With reference to the conceptual diagram shown in FIG. 1, an exemplary embodiment in accordance with the present invention includes the owner management system 150, at least one owner 100 of vacation rental property 110, and at least one publisher 140 configured to provide goods and/or services to user 120 and/or owner 100. Owner management system 150, user 120, owner 100, publisher 140 and vendor 130 are all configured to communicate with each other over a network 160 (e.g., the Internet).

User 120 may be a potential renter of vacation rental property 110. Owner 100 may be the party that owns vacation rental property 110 or an agent authorized to act on the owner's behalf.

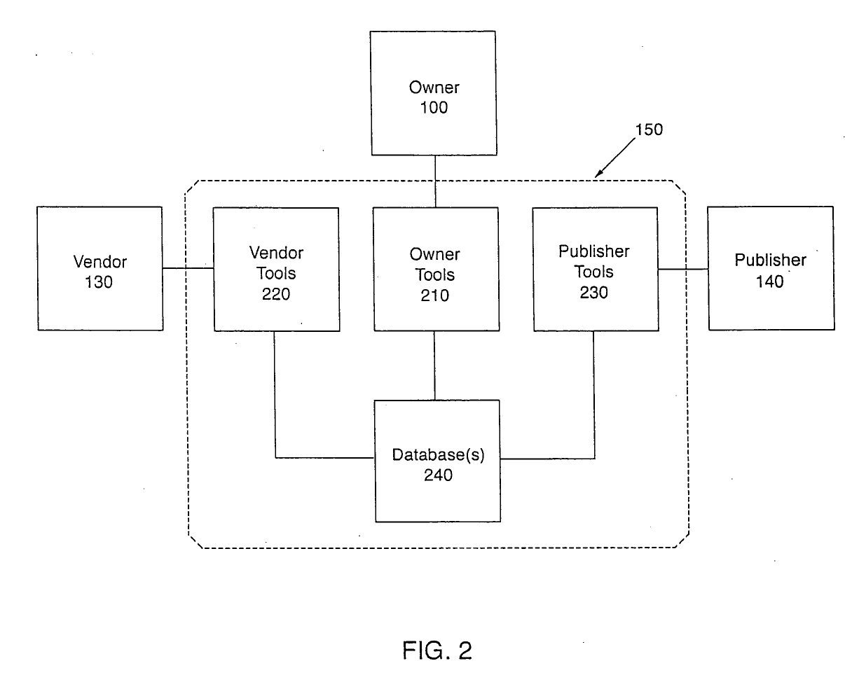

Owner management system 150 is configured to communicate with the various systems primarily to coordinate the management and listing of the vacation rental property 110 and secondarily to facilitate an income stream from user 120 to owner 100 and from owner 100 to vendor 130 and publisher 140. Owner management system 150 may perform a variety of functions, as explained in more detail below in reference to FIG. 2.

The income stream from user 120 to owner 100 is a traditional income stream derived from a rental obligation of user 120. The income stream from owner 100 to vendor 130 is also a traditional income stream derived from maintenance or housekeeping costs associated with vacation rental property 110. The income stream from owner 100 to publisher 130 is non-traditional in the sense that it is derived in response to a request received from user 120 for listing data for vacation property 110 via publisher 140. All income streams are preferably collected automatically from user 120 and owner 100 via a corresponding e-commerce module.

Publisher 140 is the entity that will issue a request for vacation rental listings to management system 150, obtain the listings from management system 150, and present the listing to the user 120. User 120 may then check the availability and/or any additional property data of specific properties of a selected property type with selected property amenities and of a selected property location, by communicating a request via a publisher 140 to management system 150.

FIG. 2 is a diagram functionally illustrating a management system consistent with the invention. The system includes an owner tools component 210, a vendor tools component 220 and a publisher/affiliate tools component 230. All of these components interface with one or more relational databases 240. To help understand the invention, other components of the management system will be explained below. Furthermore, although FIG. 2 shows a particular arrangement of components constituting management system 150, those skilled in the art will recognize that not all components need be arranged as shown, not all components are required, and that other components may be added to, or replace, those shown.

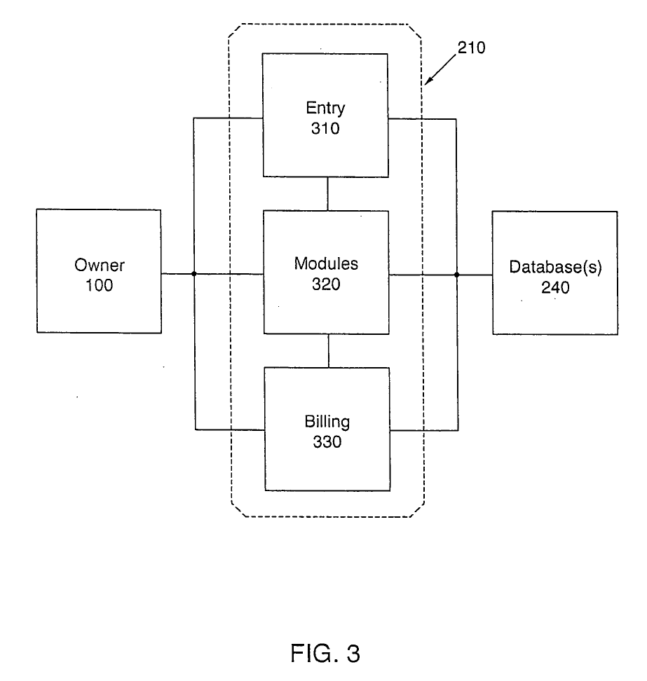

Owner tools component 210 is the component by which owner 100 enters information required for listing and managing one or more vacation rental properties. Owner tools component 210 contains a variety of tools designed to help owner 100 to manage vacation rental property 110 and also to create and monitor listings. The data required for, or obtained by, owner tools component 210 resides in a database 240. Owner tools component 210 may perform a variety of functions, as explained in more detail below in reference to FIG. 3.

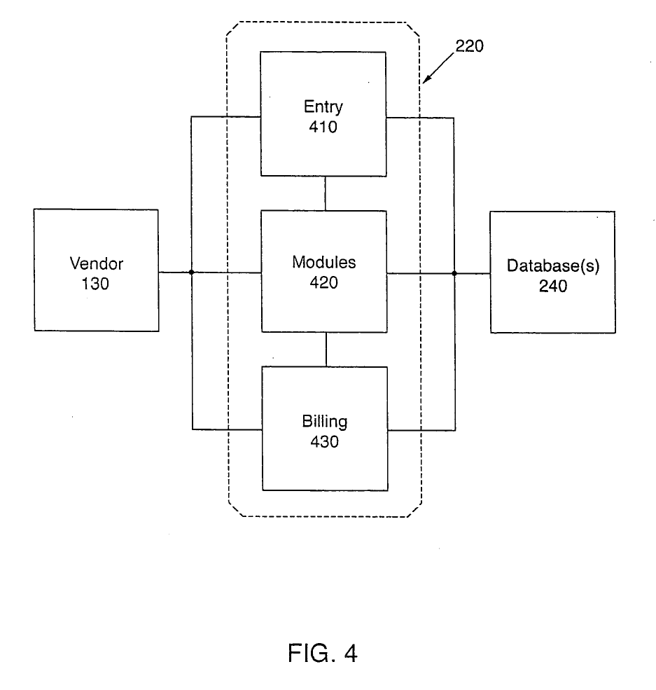

Vendor tools component 220 is the component by which vendor 130 enters information required for initiating and managing its services to owner 100. Vendor tools component 220 contains a variety of tools designed to help vendor 130 initiate, monitor, and manage its maintenance jobs associated with vacation rental property 110. The data required for, or obtained by, vendor tools component 220 resides in a database 240. Vendor tools component 220 may perform a variety of functions, as explained in more detail below in reference to FIG. 4.

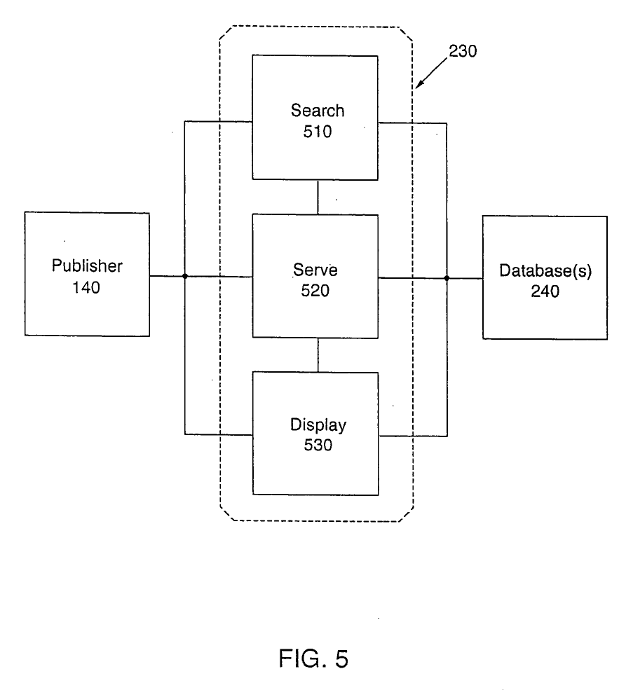

Publisher tools component 230 is a component that interfaces with publisher 140 to obtain or send vacation rental listing information. For example, publisher 140 may send a request for one or more vacation rental listings to publisher tools component 230. The data required for, or obtained by, publisher tools component 230 resides in a database 240. Publisher tools component 230 may perform a variety of functions, as explained in more detail below in reference to FIG. 5.

Databases 240 contain a variety of data used by management system 150. In addition to the information mentioned above, databases 240 may contain statistical information about what listings have been displayed, how often they have been shown, the number of times they have been selected, who has selected those listings, how often display of the listing has led to a reservation, etc. Although databases 240 are shown in FIG. 2 as one unit, one of ordinary skill in the art will recognize that multiple databases may be employed for gathering and storing information used in management system 150.

FIG. 3 is a diagram functionally illustrating an owner tools 210 component consistent with the invention. The system includes an owner entry component 310, an owner modules component 320, and an owner billing component 330. The data required for, or obtained by, owner tools component 210 resides in a database 240.

Owner entry component 310 is the component by which owner 100 enters information required for listing and managing one or more vacation rental properties. The data required for, or obtained by, owner entry component 310 resides in a database 240.

Owner modules component 320 contains a variety of modules or tools designed to help owner 100 to manage its vacation rental properties and also to create and monitor listings. For example, owner modules component 320 may contain a tool for helping owner 100 estimate the number of click-throughs a listing will receive for a particular publisher.

Other possible modules may be provided as well. Depending on the nature of the module, one or more databases 240 may be used to gather or store information.

Owner modules component 320 preferably includes the following modules: an account overview module, a properties module, a bookings module to track reservations and guest information, a tasks module to track and notify the owner of tasks associated with specific reservations such as housekeeping and security deposit refinds and the like, a finance module to track payments and expenses, a calendar module to display and amend availability information, a marketing module, and a support module.

Owner billing component 330 helps perform billing-related functions. For example, owner billing component 330 generates invoices for a particular vacation rental listing or vendor. In addition, owner billing component 330 may be used by owner 100 to monitor the amount being expended for its various vacation rental properties. The data required for, or obtained by, owner billing component 330 resides in a database 240.

FIG. 4 is a diagram functionally illustrating a vendor tools component 220 consistent with the invention. The system includes a vendor entry component 410, a vendor modules component 420, and a vendor billing component 430. The data required for, or obtained by, vendor tools component 220 resides in a database 240.

Vendor entry component 410 is the component by which vendor 130 enters information required for initiating and managing its services to an owner. The data required for, or obtained by, vendor entry component 410 resides in a database 240.

Vendor modules component 420 contains a variety of modules or tools designed to help vendor 130 initiate, monitor, and manage its maintenance or housekeeping jobs associated with a vacation rental property. For example, vendor modules component 420 may contain a tool for helping vendor 130 to schedule housekeeping jobs for a particular vacation rental. Other possible modules may be provided as well. Depending on the nature of the module, one or more databases 240 may be used to gather or store information.

Vendor billing component 430 helps perform billing-related functions. For example, vendor billing component 430 generates invoices for a particular vacation rental. In addition, vendor billing component 430 may be used by vendor 130 to monitor the amount of income associated with a particular vacation rental. The data required for, or obtained by, vendor billing component 430 resides in a database 240.

FIG. 5 is a diagram functionally illustrating a publisher tools component 230 consistent with the invention. The system includes a listing search component 510, a listing serving component 520, and a listing display component 530. The data required for, or obtained by, publisher tools component 230 resides in a database 240.

Listing search component 510 interfaces with publisher 140 to obtain or send vacation rental listing information. For example, publisher 140 may send a request for one or more vacation rental listings to search component 510. The request may include information such as the site requesting the listing, any information available to aid in selecting the listing, the number of listings requested, etc. In response, search component 510 may provide one or more vacation rental listings to publisher 140. In addition, publisher 140 may send information about the performance of the listing back to the management system via the search component 510. This may include, for example, the statistical information described above in reference to a database 240. The data required for, or obtained by, ad consumer interface component 250 resides in a database 240.

Listing serving component 520 receives an ordered list of vacation rental listings from listing search component 510, and formats that list into a manner suitable for presenting to publisher 140. This may involve, for example, rendering the listing data into hypertext markup language (“HTML”), into a proprietary data format, etc.

Listing display component 530 receives a unique vacation rental property listing identifier from publisher 140, and formats the listing data into a manner suitable for presenting to publisher 140. This may involve, for example, rendering the listing data into hypertext markup language (“HTML”), into a proprietary data format, etc.

B. Operation

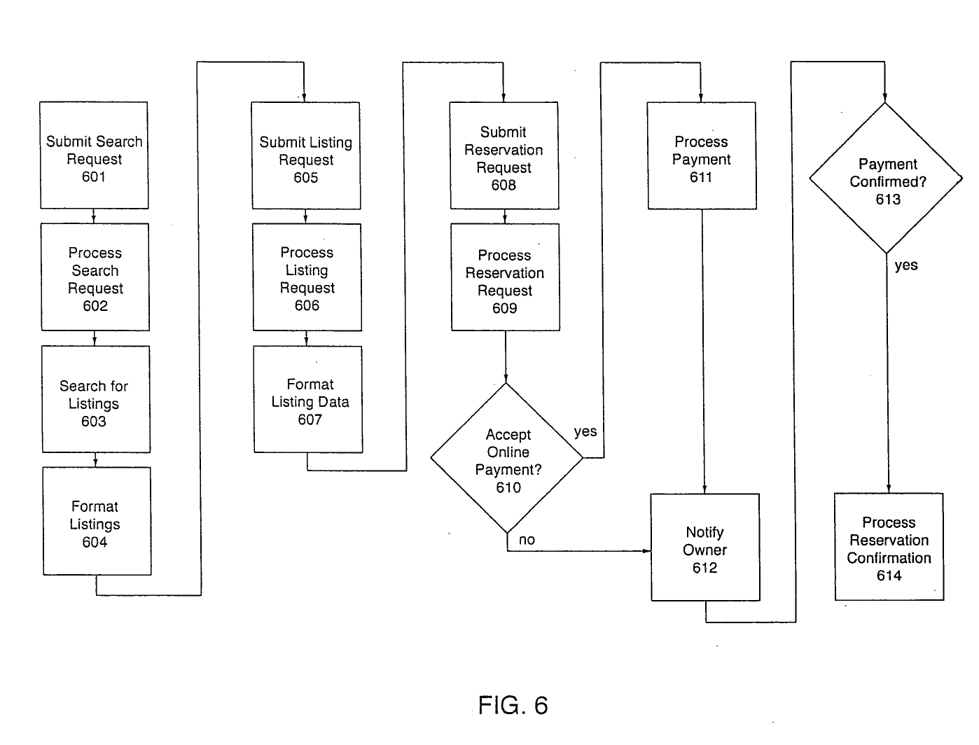

Referring to the flowchart shown in FIG. 6 in conjunction with the system overview shown in FIG. 1, an example reservation request from user 120 operates as follows. First, user 120 utilizes publisher 140 to submit a vacation rental listing search request (step 601) to management system 150. Management system 150 parses and processes the request (step 602), then searches databases 240 (step 603) for listings matching the search criteria in 601. Search criteria may include details such as location, size, amenities, availability and the like. Management system 150 then formats the search results (step 604) in a suitable format for presenting to publisher 140. This may involve, for example, rendering the listing data into hypertext markup language (“HTML”), into a proprietary data format, etc.

At this time, user 120 may browse the listings and select a particular listing of interest by submitting a listing request (step 605) to management system 150. Management system 150 receives and processes the listing request (step 606) which may include steps such as incrementing the number of times a listing has been requested and storing that data in databases 240. Management system 150 then formats the listing data (step 607) in a suitable format for presenting to publisher 140. This may involve, for example, rendering the listing data into hypertext markup language (“HTML”), into a proprietary data format, etc.

At this time, user 120 may decide to make a reservation for this vacation rental by submitting a reservation request (step 608) via publisher 140 to management system 150. Management system 150 receives and processes the reservation request (step 609) which may include steps such as querying user 120 for personal contact information and storing the reservation request and user information in databases 240. Management system 150 then determines if owner 100 accepts online rental payments (step 610). Online payments are preferably handled via a corresponding e-commerce module or a third-party provider such as PayPal.com (step 611). Management system 150 then sends a reservation request notification to owner 100 (step 612) via e-mail, web-page update, PDA, pager, or the like.

At this time, it is the responsibility of owner 100 to determine if payment has been received and confirmed (step 613) for the reservation above. Owner 100 uses management system 150 to confirm payment and management system 100 processes the confirmation (step 614) which may include steps such as updating availability data in databases 240, sending a reservation confirmation notification (via email) to user 120 and automatically scheduling housekeeping tasks associated with the reservation.

C. Conclusion

The foregoing description of preferred embodiments of the present invention provides illustration and description, but is not intended to be exhaustive or to limit the invention to the precise form disclosed. Modifications and variations are possible in light of the above teachings or may be acquired from practice of the invention.

What is claimed is:

1. A method and system for advertising, finding, browsing, managing, booking and leasing one or more real vacation rental properties from a remote location via a network such as the Internet, said method and system comprising:
a renter system and method associated with a short-term renter who desires to find, browse, inquire about, lease or make a future reservation at a real vacation rental property suited to the needs of said renter, said renter system coupled to said network;
an affiliate system and method associated with an affiliate configured to provide advertising of goods or services to said renter and/or said vacation rental; placing on web pages of said affiliate websites embedded HTML forms that are submitted by said renters to request information about said vacation rental properties; said affiliate system coupled to said network;
an owner system and method associated with an owner (or authorized agent) of said vacation rental property allowing said owner to manage and track information pertaining to: bookings, renters, tasks (e.g. housekeeping and deposit refunds), payments and expenses for said vacation rental property, to market and advertise said vacation rental property on said affiliate websites, and to screen said renters based on their rental history and to provide them with a rating; said owner system coupled to said network;
a vendor system and method associated with a vendor or service provider configured to provide goods and/or services (e.g. maintenance, housekeeping or concierge services) to said vacation rental property owner, said vendor system coupled to said network;
a search system for determining which of a number of vacation rental properties are both available and suited to the needs of said renter;
a booking system for making a booking and payment for a specified time-slot for said vacation rental property online and in real-time;
a rating system for assigning a predefined and universally understandable rating (e.g. 3 out of 4 stars) to said renter and said vacation rental property;
a server configured to electronically communicate over said network with said renter, said owner, said affiliate and said vendor;
storing, in said server, a set of specific server scripts that are selectively used to generate specific web pages;
and a relational database operatively coupled to said server.

2. The method and system of claim 1, including means for determining which of a number of vacation rental properties are both available and suited to the needs of said renter comprising:
(a) a property relational database for storing a plurality of variable attributes related to said vacation rental properties to enable rapid searching and retrieval of available properties having certain desired attributes;
(b) means for inputting to said property database a search query of certain variable attributes to search a plurality of said vacation rental properties (including but not limited to certain desirable amenities, cost, availability and geographic location);
(c) means for comparing the attributes of each said property in said property database with the inputted search query;
(d) means for displaying (either by geographic location on a dynamic map or in a list) all properties in said property database that match said search query.

3. The method and system of claim 2, wherein step (a) includes predetermining for each of the said vacation rental properties certain attributes such as, but not limited to, amenities, cost, availability and location, step (b) includes fields representative of all the information obtained in step (b) related to said attributes and step (c) includes extracting from said relational database information pertaining to the vacation rental properties which match said attributes.

4. The method and system of claim 2, wherein the search results screen includes relevant information about said vacation rental properties which match said needs including, but not limited to, location, cost, availability, amenities, contact information, image files, video files and text; said search results screen may be in the form of a web page.

5. The method and system of claim 2, wherein said search results screen may optionally include a hyperlink for each of said vacation rental properties that will direct said renter to either another screen containing more information for said vacation rental property or to a predetermined web address.

6. The method and system of claim 2, including means enabling the search results to be updated and redisplayed according to a change in the desired attributes.

7. The method and system of claim 1, including means for making a booking and facilitating payment for a specified time-slot for a selected vacation rental property online and in real-time comprising:
(a) a booking relational database for storing a plurality of variable attributes related to bookings and payments for each vacation rental property;
(b) an owner booking module configured to enable owners to manage and change the status of bookings and to create new bookings for renters not making bookings over the Internet, to create and send electronic invoices for payments for said bookings and to track said payments;
(c) and a renter booking module configured to enable a renter to book a renter-initiated booking for an available time-slot at the selected vacation rental property and to facilitate online payments via a third party payment processing provider, such as PayPal.com.

8. The method and system of claim 7, including means for dynamically generating a hyperlink that can be copied and pasted into electronic communications (such as email and the like) which when clicked directs the renter to said Internet booking module for a predetermined arrival and departure date; said hyperlink contains variable identification values such as a unique property identification number (stored in said property relational database), an arrival date value (e.g. checkin=mm/dd/yy) and length of stay value measured in days.

9. A method and system of claim 7, including means for automatically determining availability and cost information given said unique property identification number, said arrival date and said length of stay values and to facilitate online payments for said cost by coordinating with a third party payment processing provider, such as PayPal.com.

10. A method and system of claim 7, wherein bookings have an associated variable status field; booking status field options include, but are not limited to: confirmed, unconfirmed, held, inquiry, declined, cancelled, and referral.

11. A method and system of claim 7, including means for said owner to elevate or demote said status of said booking and to electronically notify (for example, a change on the renter booking module and/or sending an email) said renter of said change in status.

12. A method and system of claim 7, wherein the change in said status of said booking results in prompting said owner for additional information pertaining to said booking, for example a change in status from unconfirmed to confirmed may prompt said owner for the input of payment information for said booking.

13. A method and system of claim 7, wherein if said booking status is updated to status declined, said booking data is duplicated in said booking relational database for each vacation rental property which matches said renter's original said search query; said duplicated bookings are changed to status referral; said duplicated bookings are updated to become associated with said matching vacation rental properties; owners of said properties are electronically notified of said referral bookings.

14. A method and system of claim 7, wherein said renter-initiated booking is initially saved in said booking database with status unconfirmed.

15. A method and system of claim 7, including means for facilitating payment from said renter to said owner via electronic communication (e.g. passing variables to a program residing on a server) over said network with a third party payment processing provider (e.g. PayPal.com) and transferred from said renter's account into said owner's account automatically; said payment processor coupled to said network.

16. A method and system of claim 7, including means for electronically notifying (for example via email) said owner over said network of said booking.

17. A method and system of claim 7, wherein existing bookings with a status of confirmed or held are automatically reflected on said vacation rental property's availability calendar and are unavailable for renter-initiated bookings.

18. A method and system of claim 7, wherein a change in status of said booking to status confirmed results in the automatic update of said vacation rental property's availability calendar to reflect said confirmed booking.

19. A method and system of claim 1, wherein a unique identification number is assigned to each new row of data in said relational database in order to facilitate tracking.
